(19) United States
(12) Patent Application Publication
(10) Pub. No.: US 2017/0305028 A1
(43) Pub. Date: Oct. 26, 2017

(54) VEGETABLE CHOPPER

(71) Applicant: YING ZHANG, DONGGUAN (CN)

(72) Inventor: YING ZHANG, DONGGUAN (CN)

(21) Appl. No.: 15/312,671

(22) PCT Filed: Mar. 13, 2015
(86) PCT No.: PCT/CN2015/074180

§ 371 Date: Nov. 21, 2016

(30) Foreign Application Priority Data
Dec. 26, 2014 (CN) 201420847455.2

(51) Int. Cl. B26D 7/26; B26D 1/03; B26D 3/11; B26D 7/06

(52) U.S. Cl. CPC B26D 7/2628; B26D 7/0666; B26D 1/03; B26D 3/11; B26D 2210/02

(57) ABSTRACT

A vegetable chopper is provided and includes a base, having an upper end surface with a slideway and one end of the base corresponding to the slideway being vertically provided with a tool mounting plate, and the tool mounting plate being formed with a notch; a hand cranking rotary socket, disposed in the slideway in a slidable manner; a fixed blade, corresponding to the notch, fixed on the tool mounting plate; and further comprises: a rotary toolholder, corresponding to the notch, disposed on the tool mounting plate in a rotatable manner, having an outer side being provided with at least two sets of toothed blades in different pitches along the direction of the rotating axis of the rotary toolholder; and, a rotary mechanism, disposed on the base and connected with the rotary toolholder.

### CROSS-REFERENCE TO RELATED APPLICATIONS

This application claims priority to PCT Application No. PCT/CN2015/074180, having a filing date of Mar. 13, 2015, based off of Chinese Application No. 201420847455.2 having a filing date of Dec. 26, 2014, the entire contents of both which are hereby incorporated by reference.

### FIELD OF TECHNOLOGY

The following generally relates to a kitchen ware, in particular to a vegetable chopper.

### BACKGROUND

An existing vegetable chopper is generally comprised of a base and a hand cranking rotating socket. The upper end face of the base is provided with a slideway. The base corresponding to one end of the slideway is vertically provided with a tool mounting plate. The tool mounting plate is provided with a notch, to which a fixed blade and a set of toothed blades correspond. The hand cranking rotary socket can be disposed in the slideway in a slidable manner. In use, vegetables such as carrots and potatoes are longitudinally inserted into the hand cranking rotary socket. Then, the hand cranking rotary socket is driven to get close to the tool mounting plate along the slideway, and meanwhile an end of the vegetables is pressed against the notch of the tool mounting plate; whereafter, the handle of the hand cranking rotary socket is rotated to drive the vegetable to rotate. The vegetable is cut into strips or slices jointly by the fixed blade and the toothed blades and then the strips or slices are discharged via the notch. However, the existing vegetable chopper fails to generate different shapes of strips or slices, for the fixed blade and the toothed blades are fixedly installed on the tool mounting plate. Although, as an improvement, the tool mounting plate can be designed into an inserting structure, by which the fixed blade together with the toothed blades with different pitches can be installed on different inserting plates, the spare inserting-type tool mounting plate needs space for storage, and the exposed blade edges pose great dangers to the users while replacing the tools.

### SUMMARY

An aspect relates to a vegetable chopper, wherein various vegetable cutting functions can be realized without replacing tools.

In order to achieve the aspect, the following technical solution is adopted in embodiments of the present invention: a vegetable chopper, comprising: a base, having an upper end surface with a slideway and one end of the base corresponding to the slideway being vertically provided with a tool mounting plate, and the tool mounting plate being formed with a notch; a hand cranking rotary socket, disposed in the slideway in a slidable manner; a fixed blade, corresponding to the notch, fixed on the tool mounting plate, further comprising: a rotary toolholder, corresponding to the notch, disposed on the tool mounting plate in a rotatable manner, having an outer side being provided with at least two sets of toothed blades in different pitches along the direction of the rotary axis of the rotary toolholder; and, a rotary mechanism, disposed on the base and connected with the rotary toolholder.

Further, the rotary mechanism comprises: a driven bevel gear, disposed at the lower end of the rotary toolholder; a driving bevel gear, engaged with the driven bevel gear; a rotating shaft, transversely disposed in the tool mounting plate, having one end in connection with the driving bevel gear; and, a knob, disposed at the other end of the rotating shaft.

Further, an elastic limiting mechanism is disposed between the rotary toolholder and the tool mounting plate, the elastic limiting mechanism comprising: at least two limiting holes, disposed at the bottom end face of the rotary toolholder; a spring, corresponding to the at least two limiting holes, disposed in a spring base of the tool mounting plate; and, a steel ball, placed at one end of the spring and interfering with the bottom end face of the rotary toolholder.

Further, the rotary toolholder is a column with an equilaterally polygonal cross section, and with a set of toothed blades on each lateral face.

Further, the back face of the tool mounting plate is provided with a hood corresponding to the rotary toolholder.

Further, the back face of the tool mounting plate is provided with a plurality of reinforcing ribs.

Further, the bottom of the base is provided with manual suction plates, and the bottom of each manual suction plate is provided with a plurality of projections.

Further, the fixed blade and the rotary toolholder are disposed in a herringbone shape.

Further, the hand cranking rotary socket is provided with a boosting handle on one side.

By using the above structure, embodiments of the present invention can complete replacement of various tools through simple knob rotating operations, thus enriching its functions and making it easier and safer to access.

### BRIEF DESCRIPTION OF THE DRAWINGS

Some of the embodiments will be described in detail, with reference to the following figures, wherein like designations denote like members, wherein:

FIG. 1 is a schematic view of a stereo structure of embodiments of the present invention;

FIG. 2 is a side view of embodiments of the present invention;

FIG. 3 is a bottom view of FIG. 2;

FIG. 4 is a left view of FIG. 2;

FIG. 5 is a schematic view I of embodiments of the present invention in its working state; and

FIG. 6 is a schematic view II of embodiments of the present invention in its working state.

As shown in the figures:
1—base; 11—slideway; 12—tool mounting plate; 121—notch; 122—reinforcing rib; 123—spring base; 2—hand cranking rotary socket; 21—boosting handle; 3—fixed blade; 4—rotary toolholder; 41—toothed blade; 42—limiting hole; 43—hood; 51—driven bevel gear; 52—driving bevel gear; 53—knob shaft; 54—knob; 55—reset spring; 61—spring; 62—steel ball; 7—manual suction plate; 71—projection.

### DETAILED DESCRIPTION OF THE EMBODIMENTS

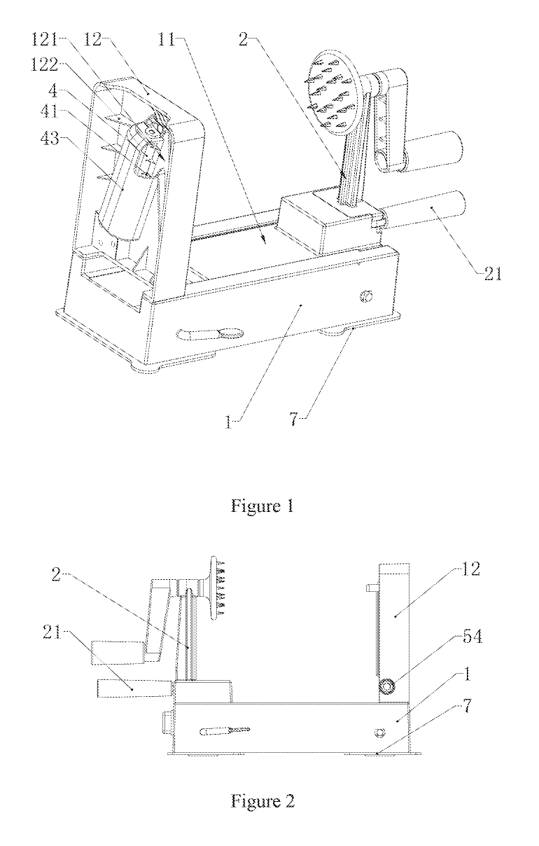

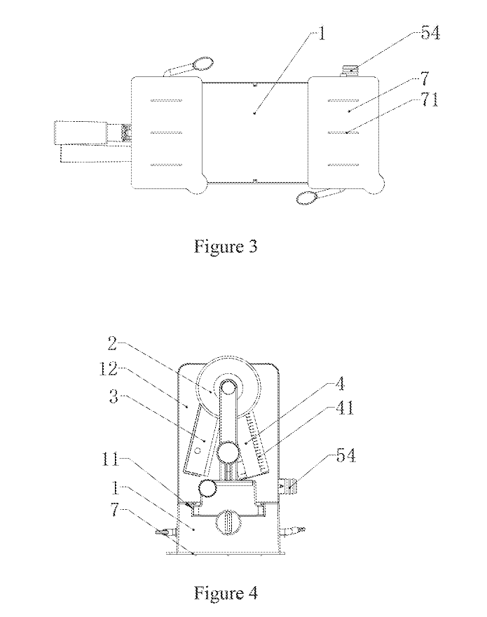

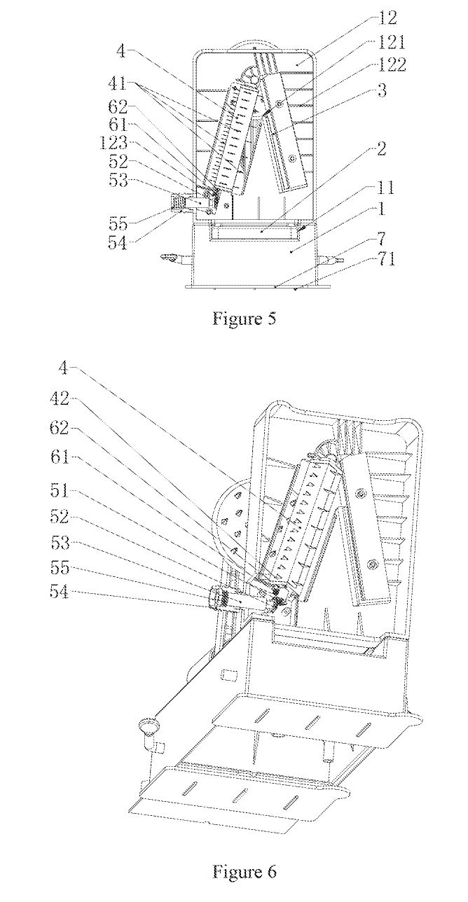

As shown in FIGS. 1-6, the vegetable chopper of embodiments of the present invention has a base 1, and the base is provided with parts including a hand cranking rotary socket 2, a fixed blade 3, a rotary toolholder 4, a rotary mechanism, an elastic limiting mechanism and manual suction plates 7.

The upper end surface of the base 1 is provided with a slideway 11, and a tool mounting plate 12 is vertically provided corresponding to one end of the slideway 11. A notch 121 which is generally herringbone-shaped is provided on the tool mounting plate 12. Also, in order to enhance the strength of the tool mounting plate, the back face of the tool mounting plate is provided with a plurality of reinforcing ribs 122.

The hand cranking rotary socket 2 is slidably disposed in the slideway 11 of the base through a slide block at its bottom. The hand cranking rotary socket 2 is also provided with a boosting handle 21.

The fixed blade 3 is fixed on one side of the herringbone-shaped notch 121 of the tool mounting plate 12 by using fastening elements such as screws.

The rotary toolholder 4 is disposed on the other side of the herringbone-shaped notch 121 of the tool mounting plate 12 in a rotatable manner. In this embodiment, the rotary toolholder 4 is a column with a square cross section. The four sides of the column are respectively provided with a set of toothed blades 41 along the direction of the rotating axis of rotary toolholder. In order to prevent the toothed blades on the back face of the mounting plate from being exposed, a hood is provided on the back face of the tool mounting plate.

The rotary mechanism is mainly comprised of a driven bevel gear 51, a driving bevel gear 52, a rotating shaft 53, a knob 54 and an elastic knob positioning mechanism. The driven bevel gear 51 is connected with the lower end of the rotary toolholder 4. The driving bevel gear 52 is engaged with the driven bevel gear. The rotating shaft 53 is transversely placed in the tool mounting plate 12 in a rotatable manner, with one end connecting with the driving bevel gear, and the other end extending out from one side of the tool mounting plate 12. The knob 54 is fixed at the end of the rotating shaft that extends out of the tool mounting plate 12, and is elastically positioned by the elastic knob positioning mechanism.

The elastic limiting mechanism is mainly comprised of four limiting holes 42 that are provided at the bottom end face of the rotary toolholder, a spring 61 and a steel ball 62. The spring 61, corresponding to the four limiting holes, is disposed in a spring base 123 of the tool mounting plate 12. The steel ball 62 is placed at one end of the spring 61 and interferes with the bottom end surface of the rotary toolholder 4.

Two manual suction plates 7 are disposed at the bottom of the base 1. In order to facilitate to lift the sucked base, the bottom of each manual suction plate is provided with three projections 71.

The working process of embodiments of the present invention is as follows:

First, the vegetable chopper is firmly fixed on a table top through the manual suction plates. Second, a piece of vegetable such as a carrot is longitudinally inserted into an inserting hole of the hand cranking rotary socket. Third, the hand cranking rotary socket is driven to get close to the tool mounting plate along the slideway and the end of the vegetable is pressed against the notch of the tool mounting plate; whereafter, the handle of the hand cranking rotary socket is rotated to drive the vegetable to rotate with one hand, and the other hand holds the boosting handle to apply a pressure, and then long vegetable is cut into strips or slices jointly by the fixed blade and the toothed blades and then discharged via the notch. At this time, the rotary toolholder is positioned by the elastic positioning mechanism of the knob and interfered by the steel ball of the elastic limiting mechanism to enter the limiting hole, and it does not rotate when stressed.

When people need to change the vegetable cutting styles and switch the toothed blades on the rotary toolholder, the positioning of the knob is released from the elastic positioning mechanism and the reset spring of the elastic positioning mechanism is stressed to compress the elastic limiting mechanism by pulling up the knob by hand; then, the knob is rotated to drive the rotating shaft to rotate, and the driving bevel gear drives the driven bevel gear to rotate, thus driving the rotary toolholder to rotate. In such circumstances, the steel ball leaves the limiting hole when driven by the rotating force of the rotary toolholder, and the spring is stressed to compress and force the steel ball to be elastically pressed against the bottom end surface of the rotary toolholder. When the rotary toolholder rotates in place, the steel ball is interfered and thus enters another limiting hole to position the rotary toolholder. Then, the knob is released, and by the effect of the restoring force of the reset spring, is positioned again by the elastic positioning mechanism. At this time, the toothed blades in different pitches on the rotary toolholder are changed, and another subsequent vegetable cutting style can be executed.

When people need to move the vegetable chopper, the manual suction plates can be lifted to release the suction, and the projections at the bottom of the suction plates make it convenient to lift the vegetable chopper.

Although the present invention has been disclosed in the form of preferred embodiments and variations thereon, it will be understood that numerous additional modifications and variations could be made thereto without departing from the scope of the invention.

For the sake of clarity, it is to be understood that the use of ‘a’ or ‘an’ throughout this application does not exclude a plurality, and ‘comprising’ does not exclude other steps or elements.

1. A vegetable chopper, comprising:
a base, having an upper end surface with a slideway and one end of the base corresponding to the slideway being vertically provided with a tool mounting plate, and the tool mounting plate being formed with a notch;
a hand cranking rotary socket, disposed in the slideway in a slidable manner;
a fixed blade, corresponding to the notch, fixed on the tool mounting plate, further comprising:
a rotary toolholder, corresponding to the notch, disposed on the tool mounting plate in a rotatable manner, and its outer side being provided with at least two sets of toothed blades in different pitches along the direction of the rotating axis of the rotary toolholder; and,
a rotary mechanism, disposed on the base and connected with the rotary toolholder.

2. The vegetable chopper according to claim 1, wherein the rotary mechanism comprises:
a driven bevel gear, disposed at the lower end of the rotary toolholder;
a driving bevel gear, engaged with the driven bevel gear;
a rotary shaft, transversely disposed in the tool mounting plate, having one end in connection with the driving bevel gear; and,
a knob, disposed at the other end of the rotating shaft.

3. The vegetable chopper according to claim 2, wherein an elastic positioning mechanism is disposed between the knob and the tool mounting plate.

4. The vegetable chopper according to claim 1, wherein an elastic limiting mechanism is disposed between the rotary toolholder and the tool mounting plate, the elastic limiting mechanism comprising:
at least two limiting holes, disposed at the bottom end surface of the rotary toolholder;
a spring, corresponding to the at least two limiting holes, disposed in a spring base of the tool mounting plate; and,
a steel ball, placed at one end of the spring and interfering with the bottom end face of the rotary toolholder.

5. The vegetable chopper according to claim 1, wherein the rotary toolholder is a column with an equilaterally polygonal cross section, and with a set of toothed blades on each lateral face.

6. The vegetable chopper according to claim 1, wherein the back face of the tool mounting plate is provided with a hood corresponding to the rotary toolholder.

7. The vegetable chopper according to claim 1, wherein the back face of the tool mounting plate is provided with a plurality of reinforcing ribs.

8. The vegetable chopper according to claim 1, wherein the bottom of the base is provided with manual suction plates, and the bottom of each manual suction plate is provided with a plurality of projections.

9. The vegetable chopper according to claim 1, wherein the fixed blade and the rotary toolholder are disposed in a herringbone shape.

10. The vegetable chopper according to claim 1, wherein the hand cranking rotary socket is provided with a boosting handle on one side.
